(19) United States
(12) Patent Application Publication
(10) Pub. No.: US 2015/0251259 A1
(43) Pub. Date: Sep. 10, 2015

(54) ROTARY SAW BLADE WITH TIPS OF VARYING LENGTH

(71) Applicant: KANEFUSA KABUSHIKI KAISHA, Niwa-gun, Aichi (JP)

(72) Inventor: Satoru Nishio, Niwa-gun (JP)

(73) Assignee: KANEFUSA KABUSHIKI KAISHA, Niwa-gun, Aichi-ken (JP)

(21) Appl. No.: 14/437,657

(22) PCT Filed: Sep. 25, 2013
(86) PCT No.: PCT/JP2013/075878

§ 371 Date: Apr. 22, 2015

(30) Foreign Application Priority Data
Oct. 22, 2012 (JP) 2012-232828

(51) Int. Cl. B23D 61/02; B23D 61/04

(52) U.S. Cl. CPC B23D 61/021; B23D 61/04; B23D 61/028

(57) ABSTRACT

A tipped saw blade is comprised of a base metal and a plurality of tips of varying length that are arranged on an outer circumferential periphery of the base metal. The plurality of tips include long tips with a setting line length in a radial direction of 4 mm or more, and short tips with a setting line length in the radial direction of less than 4 mm. The number of long tips may be between 2% to 15% of the total number of long tips and short tips combined, where the number of long tips is two or more.

### CROSS-REFERENCE TO RELATED APPLICATIONS

The present application is a National Phase entry of, and claims priority to, PCT Application No. PCT/JP2013/075878, filed Sep. 25, 2013, which claims priority to Japanese Patent Application No. 2012-232828, filed Oct. 22, 2012, both of which are incorporated herein by reference in their entireties.

### STATEMENT REGARDING FEDERALLY SPONSORED RESEARCH OR DEVELOPMENT

Not applicable.

### BACKGROUND

The present invention generally relates to a tipped saw blade for use in cutting and/or forming groove in materials such as wood, wood board, resin, ceramics and/or ceramic type material, metal, composite, and/or the like. More particularly, the present invention relates to a generally circular tipped saw blade comprising a base metal where serrated tips of varying length are arranged on a periphery of the base metal.

Conventionally, known tipped saw blades generally include a core comprising a rigid material, such as a base metal, where plurality of serrated tips are consecutively arranged on and extend from an outer periphery of the base metal. The tips may be formed from cemented carbide, polycrystalline diamond, CBN, cermet (i.e. a ceramic-metallic composite), ceramic, and/or a material coated with one or more of these materials. The tips may be configured and/or mounted on the base metal to project at a face bevel angle and/or a tangential clearance angle suitable for cutting a workpiece, such as a hard wood. The tipped saw blade is mounted to a machining apparatus and rotated thereon to cut the workpiece as desired. Various factors may determine the relative undulation amount of the cut surface of the workpiece. Such factors may include the radial clearance angle of the tipped saw blade, the relative angle of deflection of the tips during machining, and the rigidity of the base metal. For example, Japanese Patent No. 3170498 discloses a tip with a unique side surface configuration to diminish surface roughness of a cut surface of the workpiece.

In further detail, Japanese Patent No. 3170498, as discussed above, discloses a tipped saw blade mounted to a flange of a machining apparatus. The machining apparatus may be operated to axially rotate the tipped saw blade and/or rotation shaft to contact a flange-contacting surface. Further, the flange-contacting surface in contact with the tipped saw blade and/or the rotation shaft may be deflected from a desired cutting angle upon contact of the tipped saw blade with the workpiece. As a result, undulation of a cut surface of the workpiece may be increased due to such a deflection as described. Further, usage of relatively unsophisticated machining apparatuses, such as those often used in developing countries, may contribute to substantial deflection of the tipped saw blade upon contact with the rotation shaft and/or the flange contact surface at, for example, a relatively high rate of one deflection per rotation.

In light of the above, there is a need in the art for a tipped saw blade capable of reducing the amount of undulation of a cut surface of a workpiece in instances of deflection of the tipped saw blade.

### BRIEF SUMMARY OF THE DISCLOSURE

An aim of the present invention is to address the above-described problem of undulation by providing a tipped saw blade comprising a base metal with a plurality of tips of varying length arranged consecutively on an outer periphery of the base metal in a generally diametrical direction. The plurality of tips include long tips with a setting line length in a radial direction of 4 mm or more, and short tips with a setting line length in the radial direction of less than 4 mm. The number of long tips may be between 2% to 15% of the total number of long tips and short tips combined, where the number of long tips is two or more.

The tipped saw blade is mounted to both a rotation shaft of a machining apparatus and to a flange attached to the rotation shaft. The machining apparatus may be activated to rotate the tipped saw blade about the rotation shaft. However, should the flange contact surface in contact with the tipped saw blade and/or the rotation shaft be deflected during cutting a workpiece, a side surface of the tipped saw blade may also be deflected, leading to, for example, unwanted undulation during cutting. The amount of undulation noticed in the cut surface of a workpiece may be substantially diminished and/or eliminated altogether by usage of the tipped saw blade with a plurality of tips of varying length. Moreover, the tipped saw blade may be manufactured at a relatively low cost by limiting the total number of long tips, which are typically more expensive than short tips due to their length, to only 2% to 15% of the total number of long tips and short tips combined. In detail, both the long tips and the short tips are made from an expensive material such as cemented carbide or polycrystalline diamond. Thus, in comparison with the short tips, the long tips are relatively more expensive. However, as stated earlier, the total number of the long tips is limited to only 2% to 15% of the combined total of the number of long tips and short tips to form the tipped saw blade at a relatively low cost.

Substantial undulation in the cut surface of the workpiece has been observed in instances of deflection of the rotation shaft and/or the tipped saw blade where the tipped saw blade features short tips alone. In contrast, using a tipped saw blade with only long tips arranging on a periphery of the base metal of the tipped saw blade produces cut surfaces with significantly less undulation than that attributable to using short tips alone. However, manufacturing a tipped saw blade with only long tips to limit and/or eliminate undulation in the cut surfaces of a workpiece may result in high manufacturing costs, due to the costs of the raw materials required for production as described above. Nevertheless, configuring a tipped saw blade with long tips in the range of 2% to 15% of the total combined number of long tips and short tips produces undulation similar to that observed for a tipped saw blade having only long tips. Accordingly, the tipped saw blade described here reduces the amount of undulation in the cut surface of a workpiece as needed while being able to be manufactured at a relatively low cost.

### BRIEF DESCRIPTION OF THE DRAWINGS

FIG. 1 is a front view of a tipped saw blade of the present invention;

FIG. 2 is an enlarged front view of a portion of II in FIG. 1;

FIG. 3 is a cross-sectional view taken along line III-III in FIG. 1;

FIG. 4 is an enlarged cross-sectional view of a portion of IV in FIG. 3;

FIG. 5 is a cross-sectional view taken along line V-V in FIG. 1;

FIG. 6 is an enlarged cross-sectional view of a portion of VI in FIG. 5;

FIG. 7 is a schematic view for illustrating a machining of a workpiece by the tipped saw blade of the present invention;

FIG. 8 is a schematic view for showing a relationship between a deflection width of a side surface of a tip end and an undulation of a cut surface at a portion of VIII in FIG. 7;

FIG. 9 is a view for showing a relationship between feed rate of the workpiece and the undulation of the cut surface when the workpiece is machined by a tipped saw blade having a long tip that has a radial clearance angle of 1° and each setting length;

FIG. 10 is a view for showing a relationship between feed rate of the workpiece and the undulation of the cut surface when the workpiece is machined by a tipped saw blade having a long tip that has a radial clearance angle of 0.5° and each setting length;

FIG. 11 is a view for showing a relationship between the amplitude of the side surface of the tip end and the undulation of the cut surface;

FIG. 12 illustrates a modified example of FIG. 4;

FIG. 13 illustrates a modified example of FIG. 6;

FIG. 14 is an enlarged cross-sectional view of a portion near a first short tip of another modified example;

FIG. 15 is an enlarged cross-sectional view of a portion near a second short tip of another modified example; and

FIG. 16 is an enlarged cross-sectional view of a portion near a long tip of another modified example.

### DETAILED DESCRIPTION OF EXEMPLARY EMBODIMENTS

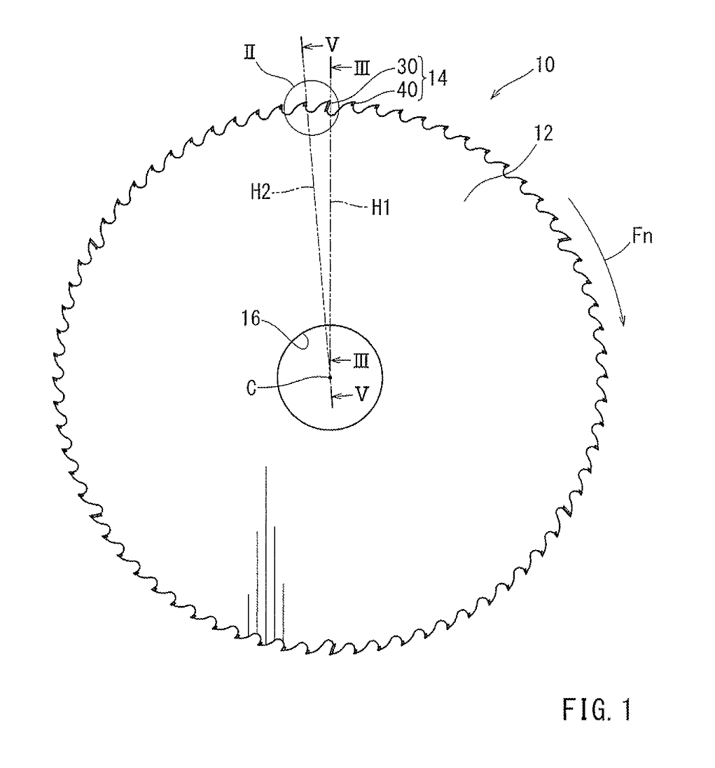

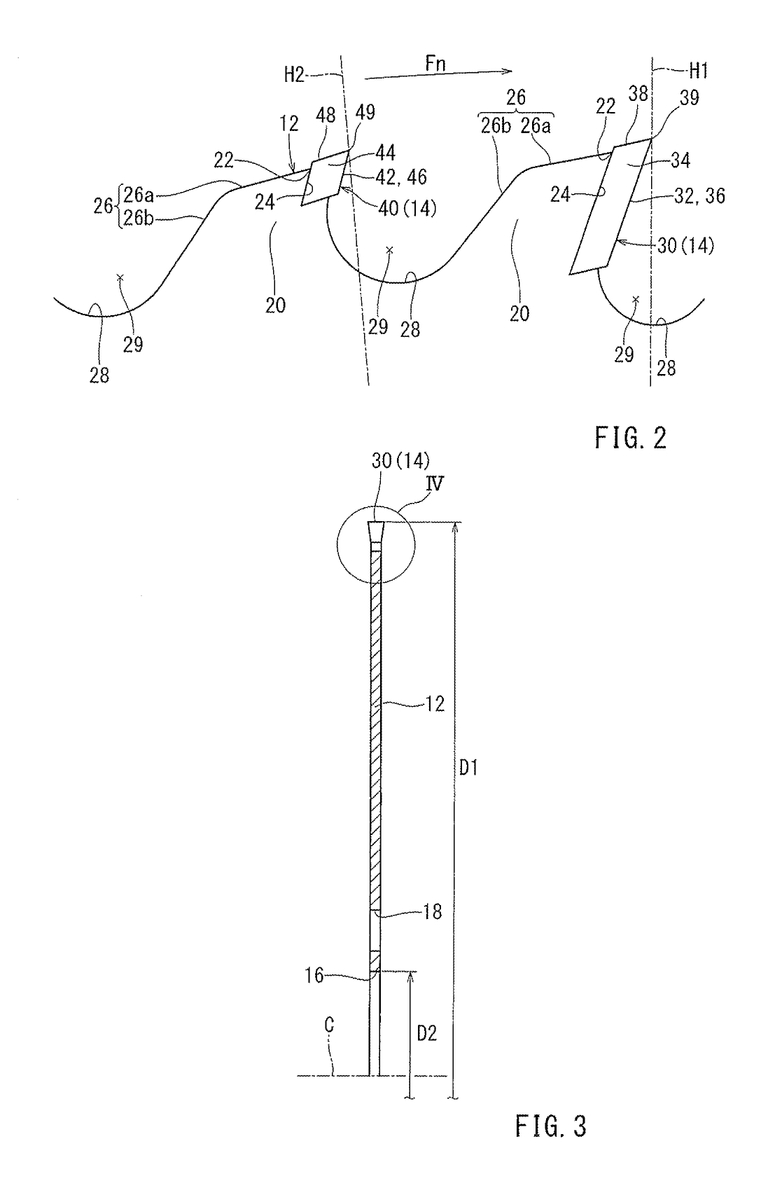

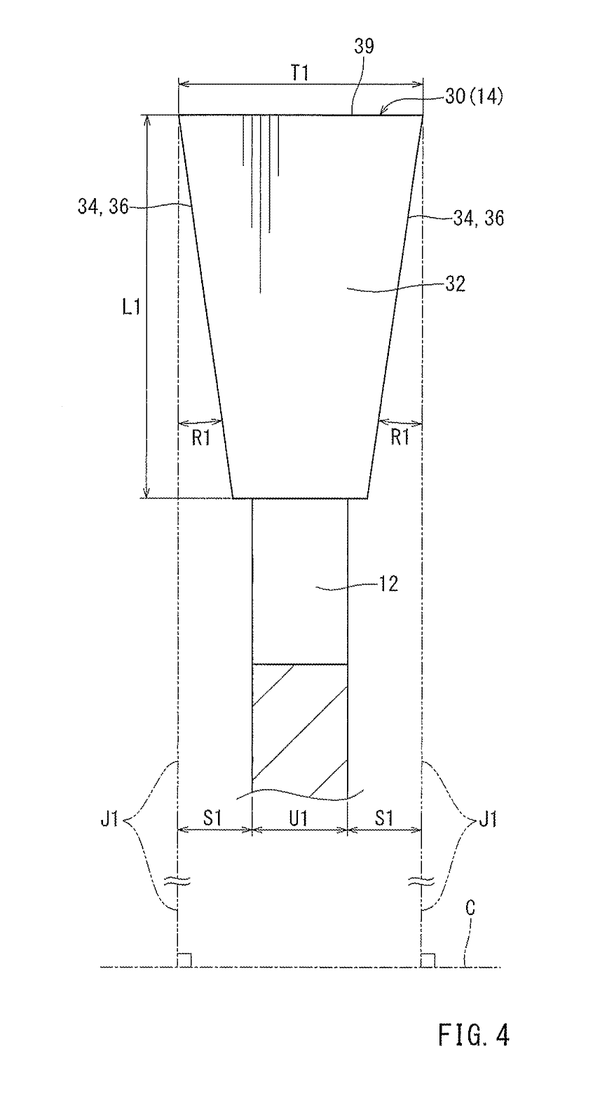

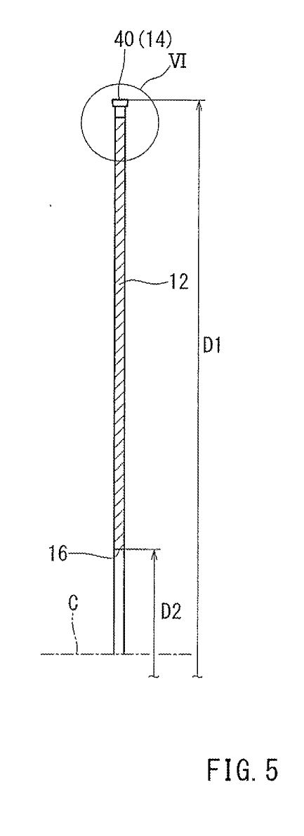

Hereinafter embodiments of the present invention will be described in further detail with reference to FIGS. 1 through 11. As shown in FIGS. 1 and 2, a tipped saw blade 10 may be generally shaped as a disc similar to such as a circular saw blade and/or a side milling cutter. The tipped saw blade 10 has a saw main body comprising of, for example, a base metal 12 and a plurality of tips 14 attached to and diametrically projecting from an outer periphery of the base metal 12, which may be shaped as a disc. A circular fit-engagement hole 16 is formed at the center of the base metal 12 and extends through the base metal 12 in the axial direction. Referring now to FIGS. 3 and 4, the width and/or thickness U1 of the base metal 12 may be determined by taking deflection rigidity into consideration, among other factors. For example, should the outer diameter D1 of the base metal 12 be 400 mm, the base metal thickness U1 may range from 2.5 to 8 mm (i.e., 3.2 mm).

Referring now to FIGS. 2-4, a plurality of serrations and/or tooth bodies 20 are attached to and project diametrically outwards from the periphery the base metal 12. In detail, as shown in FIG. 2, the plurality of tooth bodies 20 may be consecutively arranged, for example, at equal intervals relative to the circumference of the base metal 12. The tooth bodies 20 protrude diametrically outward from the base metal 12, and may be generally shaped as a chevron, for example. Each tooth body 20 culminates an apex portion 22 located toward an outermost tip in the radial and/or diametrical direction. Each apex portion 22 is situated at a forward end in the rotational direction Fn of the outer peripheral edge of the tooth body 20 and may be configured to contact and cut through a workpiece (not shown in the FIGS.) upon rotation of the tipped saw blade 10 as needed.

As shown in FIG. 2, each tooth body 20 is defined by an outer peripheral inclined surface 26 that leads to a tooth mounting surface 24. The tooth mounting surface 24 extends radially inwards (i.e., toward a center of the base metal 12 from the apex portion 22, and may be located toward a front tip of the tooth body 20 when viewed from the rotational direction Fn. The outer peripheral inclined surface 26 extends from the apex portion 22 in a direction opposite the rotational direction Fn to form the outer peripheral edge of the tooth body 20. As seen in FIG. 2, each outer peripheral inclined surface 26 has a first outer peripheral inclined surface 26a and a second outer peripheral inclined surface 26b joined thereof. The first outer peripheral inclined surface 26a extends radially inwards at a slight angle from the apex portion 22 in the direction opposite the rotational direction Fn. The second outer peripheral inclined surface 26b extends radially inwards from the first outer peripheral inclined surface 26a at an inclination angle larger than that of the first outer peripheral inclined surface 26a to shape the tooth body 20 as a chevron and/or as a hook, for example. The general shape of the tooth body 20 as a chevron may assist the tipped saw blade 10 in uniformly striking and/or contacting a workpiece to produce uniform cuts at desired angles with minimal undulation, for example.

As shown in FIG. 2, an arcuate surface 28 connects the second outer peripheral inclined surface 26b to the tooth mounting surface 24. Each arcuate surface 28 of the tooth body 20 is recessed radially inwards between tooth bodies 20 to form an exposed cavity (or gallet) 29. Further, the arcuate surface 28 may be positioned in relation to the tooth mounting surface 24 and/or the apex portion 22 to create a step-like like ledge to accept and connect with the tip 14. Further, a slit and/or a groove (not shown in the FIGS.) may be formed in and extend across the base metal 12 in a width-wise (i.e. a thickness) direction. In detail, the slit (not shown in the FIGS.) may extend radially inwards from the cavity 29 or, for example, some other slit, formed in the base metal 12. To fabricate the base metal 12 with the tooth mounting surfaces 24, the base metal 12 may be initially cut out of a steel plate by laser and/or the like. Next, a miller cutter and/or the like may be used to machine the tooth mounting surfaces 24, etc. as desired.

As shown in FIG. 2, a tip 14 may be adhered to each tooth mounting surface 24 by brazing, a metal joining process involving heating a filler metal, such as a brazing material and/or the like, above its melting point to then distribute the filler metal between two or more close-fitting parts, such as the tip 14 and the tooth mounting surface 24, to join the parts. In detail, the tip 14 may be generally configured to have a rectangular and/or trapezoidal cross-section, and may be formed from a rigid material such as cemented carbide or cermet. Alternatively, the tip 14 may be formed from a high-hardness sintered material such as polycrystalline diamond to exhibit high hardness properties. In an embodiment shown by FIGS. 1 and 2, for example, the tips 14 include both long tips 30 that have a relatively long contact surface, and short tips 40 that have a contact surface relatively shorter than that of the long tips 30.

As shown in FIGS. 2 and 4, each long tip 30 has a rake face 32, a side surface 34 and an outer peripheral flank face 38. The rake face 32 may be positioned to face toward the rotational direction Fn, opposite to the outer peripheral inclined surface 26. The side surface 34 may connect with and extend from the rake face 32. In detail, the side surface 34 may be positioned substantially orthogonal to the rake face 32 and substantially parallel to the base metal 12. Further, a side surface cutting edge 36 may be formed where the rake face 32 and the side surface 34 meet each other. Also, the outer peripheral flank face 38 connects with and extends from the rake face 32 at an acute angle, and is directed outwards in the radial direction relative to the circular fit-engagement hole 16 of the base metal 12. The rake face 32 meets the outer peripheral flank face 38 to form an outer peripheral cutting edge 39 configured to, for example, contact a workpiece to cut the workpiece as desired.

As shown in FIGS. 2 through 4, the forward-facing end (i.e. in the Fn direction) of each long tip 30 protrudes outwards in the radial direction from the base metal 12. Also, the long tip 30 extends slightly in the thickness direction (i.e., the axial direction) from the base metal 12. The tooth thickness Ti of the long tip 30 ranges from 2.6 to 10 mm depending on, for example, the width and/or thickness of the base metal 12. For example, when the outer diameter D1 is 400 mm, the tip 14 may be formed to have tooth thickness Ti of 4.4 mm.

In an embodiment, the short tips 40 may be fabricated to have a generally similar size, shape and/or cross-section as the long tips 30. In detail, as shown in FIGS. 2, 5, and 6, each short tip 40 has a rake face 42, a side surface 44, a side cutting edge 46 (i.e.

that may be identical to the rake face 42), an outer peripheral flank face 48, and an outer peripheral cutting edge 49. For example, the tooth thickness T2 of each short tip 40 may range from 2.6 mm to 10 mm (i.e. the tooth thickness T2 of each short tip 40 may be 4.4 mm when the outer diameter D1 is 400 mm).

As shown in FIG. 4, each long tip 30 has a radial clearance angle R1, a setting amount S1, and a setting line length L1. The side surfaces 34 of the long tip 30 are inclined at the radial clearance angle R1 from both axial ends of the outer peripheral cutting edge 39 generally toward the center of the base metal 12. In detail, the side surface 34 and the radial line J1 may define the radial clearance angle R1. Thus, the side surfaces 34 may extend radially inwards from both axial ends of the outer peripheral cutting edge 39 by the radial clearance angle R1. The radial lines J1 may extend in the radial direction from the outer peripheral cutting edges 39 or, alternatively, the outer ends in the thickness direction of the rake face 32. Along an imaginary plane H1 as shown in FIG. 2, the radial lines J1 extend from the axial end edges of the outer peripheral cutting edge 39 toward, and are orthogonal to, a center axis C of the tipped saw blade 10. The imaginary plane H1 may include the outer peripheral cutting edge 39 (i.e. located at the forward end on the outer side of the base metal 12 in the radial direction of the long tip 30) and the center axis C of the tipped saw blade 10.

The setting amount S1 may be defined as the distance measured in the width and/or thickness direction between the outer end in the thickness direction of the outer peripheral cutting edge 39 or the rake face 32 and the surface of the base metal 12. The setting line length L1 may be defined by the radial length between the outer end in the radial direction of the rake face 32 and the inner end edge thereof as shown in detail in FIG. 4. The setting line length L1 is the radial length of the side surface 34 as measured by using, for example, the radial line J1 as the reference.

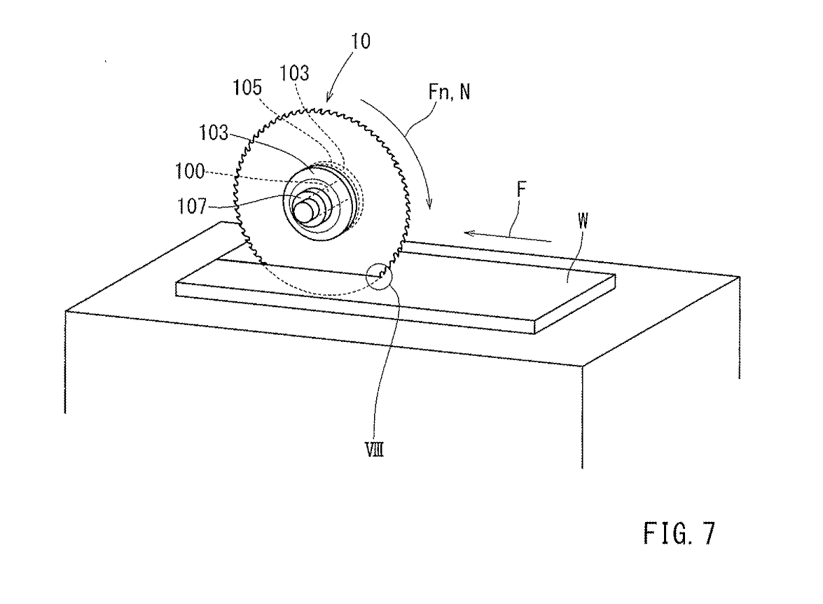

In an embodiment, the setting line length L1 of the long tip 30 may be 4 mm or more, preferably within the range of 4 to 12 mm. In detail, satisfactory reduction of undulation noticed in a cut surface of a workpiece (i.e. such as a workpiece W as shown in FIG. 7) during machining may not be possible with, for example, the setting length L1 of the long tip 30 at less than 4 mm. In contrast, fabricating the saw blade 10 with a setting line length L1 in excess of 12 mm may result in additional production costs. Thus, in view of a desire to reduce undulation during cutting and/or machining a workpiece while also controlling manufacturing costs of the tipped saw blade 10 as discussed above, the setting line length L1 may be preferably set from 4 to 8 mm.

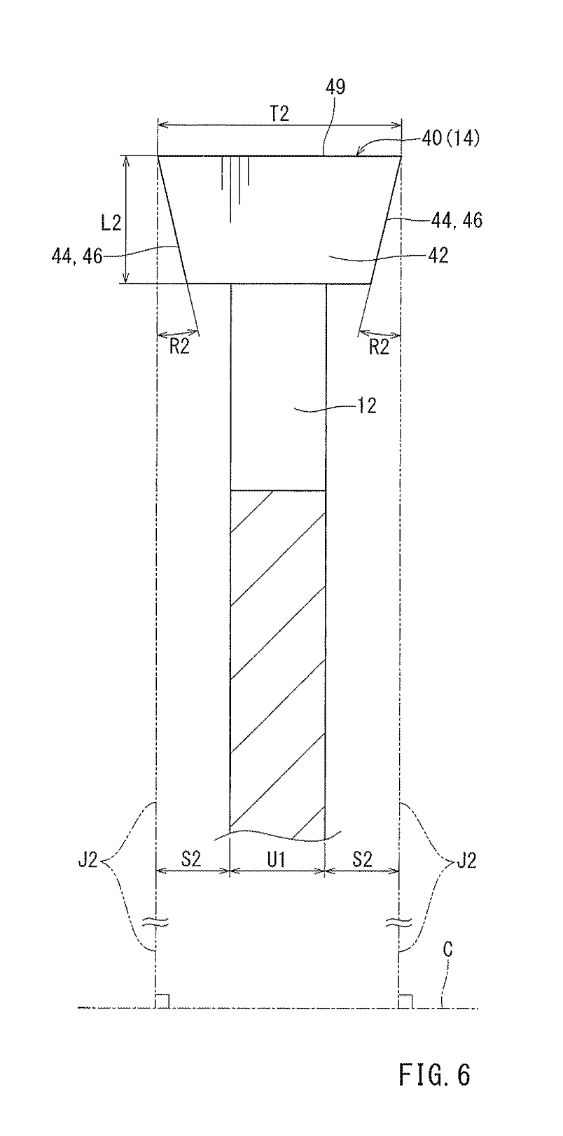

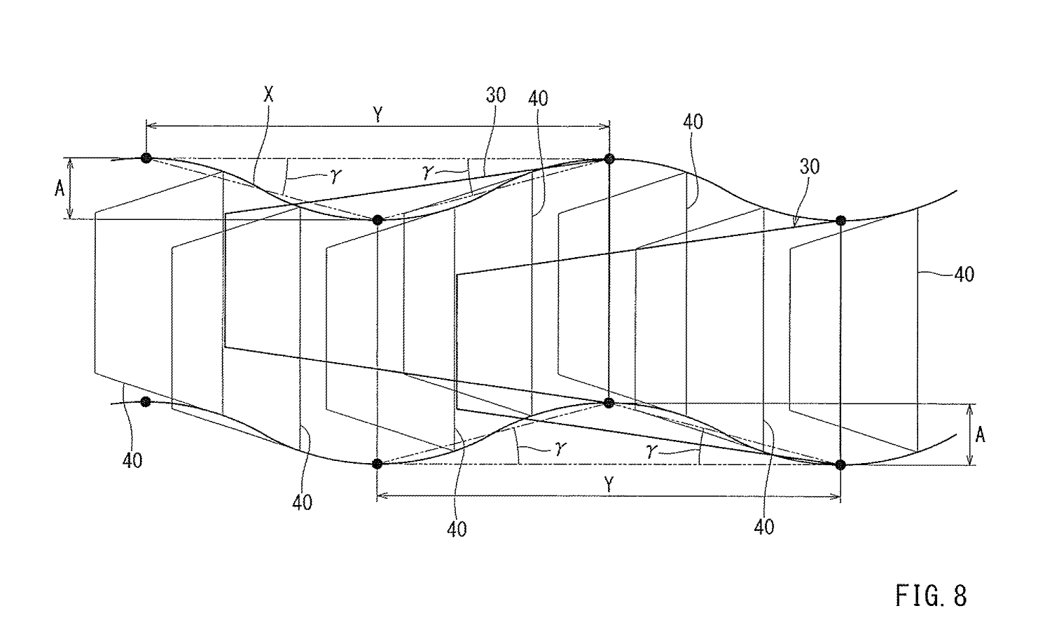

As shown in FIG. 4, the radial clearance angle R1 of the long tip 30 may range from 0° to 1.0°. Referring generally now to FIG. 7, the tipped saw blade 10 may be mounted on a rotation shaft 100 and a flange contact surface 105 such that the tipped saw blade 10 may be rotated to cut and/or machine a workpiece W. In detail, during cutting of the workpiece W, the rotation shaft 100 and/or the contact surface 105 may move and/or deflect from an initial set position to cause undulation X in the machined section of the workpiece W as shown in further detail in FIG. 8. As generally shown in FIG. 4, for example, the radial clearance angle R1 of the long tip 30 may be configured and/or set to be less than 0° (i.e., in the case of a negative radial clearance angle). Such a negative radial clearance angle of the long tip 30 may result in the tipped saw blade 10 experiencing an increase in cutting resistance while cutting the workpiece W. Further, the tipped saw blade 10 may be deflected during cutting, as described earlier, to cause additional undulation X in the workpiece W and/or burning of the tip 14. In contrast, the radial clearance angle R1 of the long tip 30 may be configured and/or set to be larger than 1.0° to reduce contact of the side surface 34 with the workpiece W. However, as a result, the amount of undulation prevalent in a cut surface of the workpiece W may not be effectively diminished. In view of the above, the radial clearance angle R1 of the long tip 30 may be configured and/or set between from 0.2° to 0.8° (preferably, from 0.3° to 0.7°) to control and/or diminish undulation X while cutting the workpiece W without, for example, burning the tip 14. Further, the radial clearance angle R1 of the long tip 30 (as shown in FIG. 4) may be configured and/or set to be the same as the radial clearance angle R2 of the short tip 40 (as shown in FIG. 6) to control and/or reduce production costs of the tips 14 of the tipped saw blade 10.

As shown in FIG. 6, the short tip 40 has the radial clearance angle R2, a setting amount S2 and a setting line length L2. In detail, the radial clearance angle R2 may be defined as the angle between the side surface 44 and the radial line J2. In general, the radial line J2, the radial clearance angle R2 and the setting line length L2 of the short tip 40 may be analogous to the radial line J1, the radial clearance angle R1, and the setting line length L1 of the long tip 30.

In detail, the radial lines J2 extend in an imaginary plane H2 (as shown in FIG. 2) from the outer peripheral cutting edge 49, and are orthogonal to the center axis C of the tipped saw blade 10. The imaginary plane H2 includes the outer peripheral cutting edge 49 (i.e., the forward-facing end of the short tip 40 in the Fn direction) and the center axis C of the tipped saw blade 10. The radial clearance angle R2 may be defined between the side surface 44 and the radial line J2 in the width and/or thickness direction. In detail, the side surfaces 44 may be directed radially inwards from the outer peripheral cutting edge 49 by the radial clearance angle R2 as shown in FIG. 6. The setting line length L2 is the length of the side surfaces 44 in the radial direction of the tipped saw blade 10 as measured, for example, using the radial lines J2 as the reference. The setting amount S2 is the distance between the base metal 12 and the radial line J2.

In an embodiment, the length L2 of the setting line of the short tip 40 may be less than 4 mm. Preferably, all the short tips 40 may be configured to have a setting line length L2 of ranging from 1 mm to 2 mm. Configuring the short tip 40 to have a setting line length L2 of less than 1 mm may contribute to a relatively short service life of the short tip 40 due to heightened wear during machining In contrast, configuring the short tip 40 to have a setting line length L2 of 2 mm or more may add to manufacturing costs of the tipped saw blade 10.

As shown in FIG. 6, the radial clearance angle R2 of the short tips 40 may range from 0° to 1.0°. Similar to that discussed above for the long tip 30, the tipped saw blade 10 may be fabricated to have short tips 40 each with a radial clearance angle R2 of less than 0° (i.e. a negative radial clearance angle). However, such a configuration as described above (i.e. a negative radial clearance angle) may increase the resistance experienced by the tipped saw blade 10 while cutting the workpiece W. Such resistance may also increase the amount of undulation X prevalent in cuts of the workpiece W.

As shown in FIG. 1, the number of long tips 30 may be between 2% to 15% of the total number of the long tips 30 and the short tips 40 combined, where the number of long tips 30 is two or more. For instance, should the tipped saw blade 10 be fabricated such that the number of the long tips 30 is less than 2% of the sum total of the both the long tips 30 and the short tips 40, the tipped saw blade 10 may experience difficulty in adequately reducing the amount of undulation X prevalent in a cut surface of the workpiece W. In contrast, fabricating the tipped saw blade 10 with the number of long tips 30 at more than 15% of the total number of combined long tips 30 and short tips 30 may contribute to additional manufacturing costs. Thus, in an embodiment, the tipped saw blade 10 may have seventy-two tips 14 in total, of which an optimal number of the long tips 30 may be six, and an optimal number of the short tips 40 may be sixty-six.

The long tips 30 may be arranged along the periphery of the tipped saw blade 10 at unequal angle intervals relative to, for example, the center of the tipped saw blade 10. However, preferably, in an embodiment, the long tips 30 may be arranged at equal angle intervals relative to the center of the tipped saw blade 10. As a result, the undulation X of a machined section as shown in FIG. 8 resultant from deflection of the rotation shaft 100 and the flange contact surface 105 shown in FIG. 7, may be generated at equal intervals. Thus, the workpiece W may be uniformly cut by the tipped saw blade 10. Likewise the amount of undulation prevalent in each cut surface of the workpiece W may also be uniformly diminished.

As shown in FIG. 7, the rotation shaft 100 may be inserted horizontally through both an electric motor (not shown in the FIGS.) and the fit-engagement hole 16 located at the center of the tipped saw blade 10. Further, a flange 103 may attach to an exposed end of the rotation shaft 100 to abut and/or compress against the tipped saw blade 10. The flange 103 has a flange contact surface 105 that may contact the base metal 12 of the tipped saw blade 10. Also, as shown in FIGS. 1 and 7, the rotation shaft 100 may insert and/or thread through the fit-engagement hole 16 of the base metal 12 and be held in place as needed by a fastening nut 107 to accommodate rotation of the tipped saw blade 10. In detail, an electric motor (not shown in the FIGS.) may be coupled with the rotation shaft 100 to rotate the rotation shaft 100, and the tipped saw blade 10 attached thereof, in the rotational direction Fn at a predetermined rotational rate, denoted by RPM N in FIG. 7. Further, the workpiece W may be fed toward the rotating tipped saw blade 10 at a predetermined feeding speed F to contact and be cut by the tipped saw blade 10.

Operation of the tipped saw blade 10 (i.e. specifically, the long tips 30 of the tipped saw blade 10) to machine and/or cut the workpiece W will be described in further detail below. FIG. 8 shows a schematic of an undulation X produced by a surface deflection of width A on the workpiece W. The tip side surface deflection width A may be generated when the rotation shaft 100 and the flange contact surfaces 105 of the tipped saw blade 10 are deflected. In detail, a deflection of width A of a side surface may produce the undulation X while the workpiece W is cut.

For the purposes of explanation below, the tipped saw blade 10 may be fabricated and/or configured to include only short tips 40. Thus, as a result of the tipped saw blade 10 making one rotation, the outer peripheral cutting edges 49 of the short tips 40 may form a wave-like cutting path, shown by undulation X, in the workpiece W. In detail, the short tips 40 cut the workpiece W along a route of the undulation X. The undulation X may exhibit a height that is approximately the same as the tip side surface deflection width A. In detail, the undulation X shown in FIG. 8 represents an amount of undulation in a cut surface of the workpiece W. However, and as described in detail earlier, the tipped saw blade 10 may be equipped with the long tips 30 addition to the short tips 40 for improved cutting of the workpiece W (i.e. to produce cuts with minimal undulation X while also minimizing unwanted deterioration of the tips 14, for example). The long tips 30 have a setting line length L1, shown in FIG. 4, which is longer than that of the short tips 40, shown in FIG. 6. The relatively long length of the long tips 30 relative to the short tips 40 allows for substantially flat and/or uniform cutting of the workpiece W (i.e. even if the tipped saw blade 10 is deflected), to thus produce cuts with minimal undulation X. As a result, the undulation X prevalent on a cut surface of the workpiece W may be diminished.

As shown in FIGS. 7 and 8, the general shape of the undulation X may be influenced by at least three factors, for example: the RPM N of the tipped saw blade 10, the feeding speed F of the workpiece W, and the tip side surface deflection width A. The undulation X illustrates a representative cutting path through the workpiece W. In detail, the outer peripheral cutting edges 49 of the short tips 40 may waver with respect to the width-wise direction of the workpeice W per rotation of the tipped saw blade 10 to produce the undulation X.

The distance Y mm, as shown in FIG. 8, is the length of the undulation X per rotation of the tipped saw blade 10. The distance Y mm may be proportionate to the feeding speed F m/min and the RPM N. In detail, the distance Y mm may be approximated by the equation: Y=(F×1000)/N. The maximum height and/or width of the undulation X may be approximately the same as the tip side surface deflection width A. The area and/or dimensions of the undulation X may be approximated by the triangle as indicated by the imaginary (dashed) lines shown in FIG. 8. In detail, the base of the triangle corresponds to the distance Y, and the height thereof corresponds to the tip side surface deflection width A. Further, the angle y of the triangle may be approximated by the equation: γ=2A/Y. The amount of undulation X prevalent in a cut surface of the workpiece W may be diminished and/or minimized by adjusting the radial clearance angle R1 of the long tips 30, as shown in FIG. 4, to be, for example, smaller with respect to the angle γ of the undulation X.

In view of the relationship between the angle γ of the undulation X and the radial clearance angle R1 of the long tips 30 as described above and a desire to diminish the undulation X, the tipped saw blade 10 may be optimally used in an RPM range of 1000 to 5000 rpm.

Further, in view of the relationship between the angle γ of the undulation X and the radial clearance angle R1 of the log tips 30, the feeding speed F of the workpiece W, as shown in FIG. 8, may range from 5 to 120 m/min. When, for example, the feeding speed F is less than 5 m/min, the amount of undulation X of the cut surface of the workpiece W is minimized, but the machining throughput rate is reduced (i.e., fewer workpieces W and/or a shorter overall length of the workpiece W may be cut by the tipped saw blade 10 during a unit period of time, for example). In contrast, when the feeding speed F is higher than 120 m/min, the amount of undulation X prevalent in the cut surface of the workpiece W is rather large. In view of the relationship between the machining rate and the undulation amount of the cut surface of the workpiece W as described above, the feeding speed F of the workpiece W may be moderated to range from 20 to 80 m/min to achieve optimal cutting efficiency while minimizing the undulation X in the cut surface of the workpiece W.

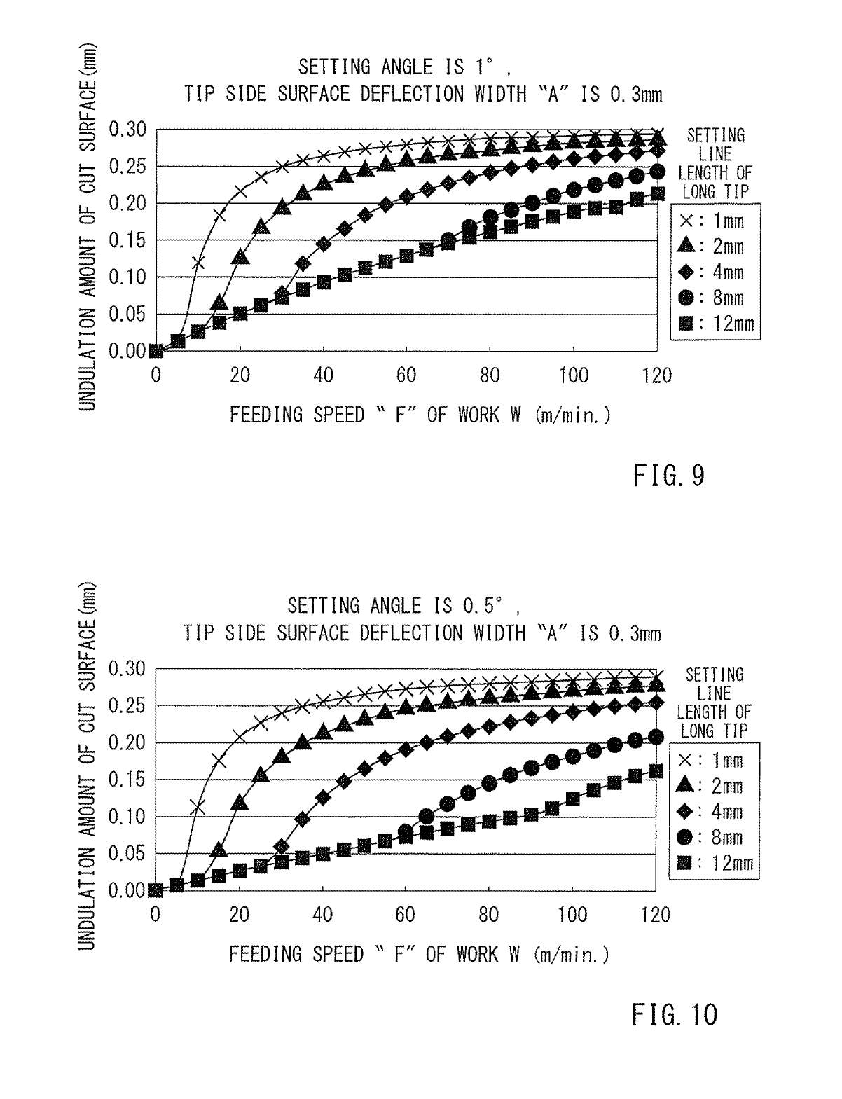

Next, the relationship between the setting line length L1 of the long tips 30 and the undulation amount of the cut surface of the workpiece W will be described in further detail. Also, the above relationship will be described when the tip side surface deflection width A is 0.3 mm. In detail, the tipped saw blade 10 may be fabricated to have short tips 40 with the radial clearance angle R2 set at 1° and the setting line length L2 set at 1 mm. Further, long tips 40 may be dispersed along the periphery of the tipped saw blade 10 in front of and/or behind the short tips 30 as shown in, for example, FIG. 1 (i.e. a number of short tips 30 may be arranged consecutively along the periphery of the tipped saw blade 10 to be followed by a long tip 40, etc.) Next, the undulation amount X of the cut surface of the workpiece W at various feeding speeds F was measured. In detail, the long tips 30 were configured to have the radial clearance angle R1 set at 1° and the setting line length L1 set at 2 mm, 4 mm, 8 mm, or 12 mm. The undulation X amount of the cut surface of the workpiece W at various feeding speeds F was measured relative to the various setting line lengths L1 of 2 mm, 4 mm, 8 mm, or 12 mm respectively, and the measurement results are shown in FIG. 9.

Next, the relationship described above will be further discussed for the long tips 30 with the radial clearance angle R1 set at 0.5°. Similar to the long tips 30 discussed here, the short tips 40 may be configured to have the radial clearance angle R2 set at 0.5° and the setting line length L2 set at 1 mm to, for example, accommodate the tip side surface deflection width A of 0.3 mm. And, analogous to that discussed above for the radial clearance angles R1 and R2 both set at 1°, the short tips 40 with the radial clearance angle R2 of 0.5° may be arranged consecutively along the periphery of the tipped saw blade 10. Long tips 30, also with the radial clearance angle R1 set at 0.5°, may be arranged intermittently along the periphery of the tipped saw blade 10 as well, for example in front or and/or behind the short tips 40. Next, the undulation amount X of the cut surface of the workpiece W at various feeding speeds F was measured. In detail, the long tips 30 were configured to have the radial clearance angle R1 set at 0.5° and the setting line length L1 set at 2 mm, 4 mm, 8 mm, or 12 mm. The undulation X amount of the cut surface of the workpiece W at various feeding speeds F was measured relative to the various setting line lengths L1 of 2 mm, 4 mm, 8 mm, or 12 mm respectively, and the measurement results are shown in FIG. 10.

As be seen from that shown by FIGS. 9 and 10, the tipped saw blade 10 with a 1 mm or 2 mm setting line length L1, the amount and/or extent of undulation prevalent in the cut surface of the workpiece W may be relatively substantial when the feeding speed F of the workpiece W is less than 20 m/min. Also, the amount of undulation prevalent in the cut surface of the workpiece W may also be large when the feeding speed is close to or at 20 m/min. As discussed above, the feeding speed F of the workpiece W may be 20 m/min or more for efficient machining, for example. Thus, usage of the long tips 30 with the setting line length L1 of 1 mm or 2 mm is not desirable for the substantial undulation associated thereof.

Further, as can be seen from FIG. 9, using a tipped saw blade 10 with the setting line length L1 set at 4 mm and the radial clearance angle R1 set at 1° results in the amount of undulation of the cut surface of the workpiece W abruptly increasing when the feeding speed F of the workpiece W is about 30 m/min (i.e., the undulation amount may be 0.08 mm or more). Moreover, as shown by FIG. 10, when the setting line length L1 is 4 mm, and the radial clearance angle R1 is 0.5°, the amount of undulation of the cut surface of the workpiece W abruptly increases when the feeding speed F of the workpiece W is close to 25 m/min (i.e., the undulation amount is 0.04 mm or more).

To both limit undulation prevalent in the workpiece W during machining while accommodating throughput as needed, the feeding speed F of the workpiece W may be set at 20 m/min or more. In accordance with that shown by both FIGS. 9 and 10 and discussed above, usage of tips with the setting line length L1 of 4 mm or more as the long tips 30 may limit undulation. Further, configuring the tipped saw blade 10 to have the tips 14 set at a radial clearance angle R1 of 0.5° may minimize undulation prevalent in a cut surface of the workpiece W relative to a radial clearance angle R1 of 1°, as shown by FIGS. 9 and 10.

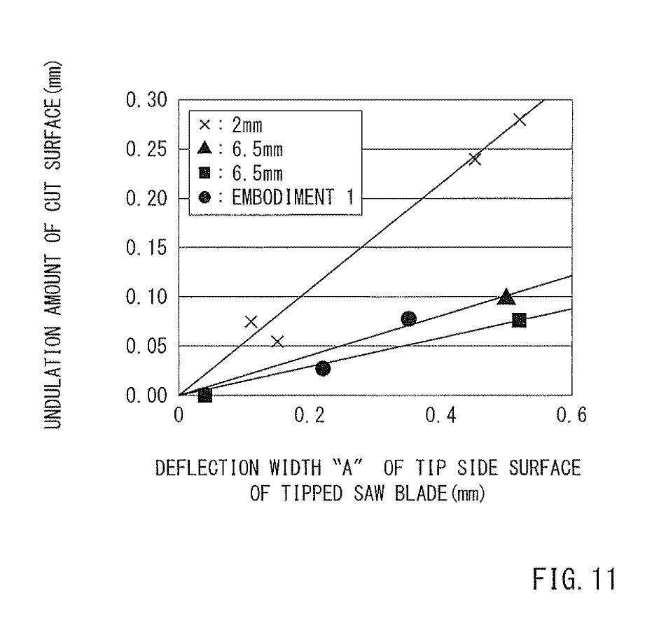

FIG. 11 shows the relationship between the tip side surface deflection width A and the undulation amount of the cut surface of the workpiece W during machining using the tipped saw blade 10. Although not identified in FIG. 7, the workpiece W may be formed from, for example, melamine-attached medium-density fiberboard (i.e., “MDF”). Such a melamine-attached MDF may integrally include MDF as a base material and a melamine-impregnated sheet heat-pressed to the surface of the MDF. In detail, the MDF may be fabricated by mixing wood chips with adhesive materials and performing heat-pressure molding thereon to form the MDF as desired. Also, two melamine-attached MDFs, each with a thickness of 15 mm, may be superimposed one on top of the other, to result in a total combined MDF thickness of 30 mm.

In an embodiment generally shown by FIGS. 3 and 4, the outer diameter D1 of the tipped saw blade 10 is 400 mm, the thickness U1 of the base metal 12 is 3.2 mm, the hole diameter D2 is 75 mm, and the number of tooth bodies 20 is 72. Further, the tipped saw blade 10 of embodiment 1 may be configured to have six long tips 30. Also, in an embodiment, the thickness T1 of the long tips 30 is 4.4 mm, the setting line length L1 is 8 mm, and the radial clearance angle R1 is 1°. The log tips 30 may be arranged at equal center angle intervals, with the center angle being 60°. In detail, and as shown by FIG. 1, for example, the tipped saw blade 10 of embodiment 1 may have 66 short tips 40. The short tips 40 may be formed to have a thickness T2 of 4.4 mm, a setting line length L2 of 2 mm, and a radial clearance angle R2 of 1°.

In an embodiment, referring generally now to FIG. 7, the diameter of the flange 103 of the machining apparatus may be 120 mm, the tipped saw blade 10 may be rotated at a rotational speed of 3600 RPM N, and the feeding speed F of the workpiece W may be set to 39 m/min. The amount of undulation prevalent in a cut surface of the workpiece W was measured with the tip side surface deflection width A of the tipped saw blade 10 set to 0.22 mm and 0.35 mm, as shown by the solid circles in FIG. 11. As shown in FIG. 11, the measured undulation amount of the cut surface of the workpiece W is approximately 0.03 mm when the tip side surface deflection width A is 0.22 mm. Likewise, the measured undulation amount of the cut surface of the workpiece W is approximately 0.08 mm when the tip side surface deflection width A is 0.35 mm.

Similarly, the undulation prevalent in a cut surface of the workpiece W was measured across various other tip side surface deflection widths A, to be described in further detail below. For example, a measurement was performed with the tipped saw blade 10 configured with a total of seventy-two tips of equal length. Such tips 14 of the aforementioned example were configured to have a setting line length of 2 mm, and a radial clearance angle of 1°. The tip side surface deflection width A of the tipped saw blade 10 was set to 0.10 mm, 0.15 mm, 0.45 mm or 0.52 mm. Other conditions, dimensions and/or parameters were kept consistent with that described in the earlier embodiments. Crosses, as shown in FIG. 11, indicate the results of measurements performed for the above-described example. In detail, as shown in FIG. 11, the undulation amounts measured for the above-discussed tip side surface deflection widths A of 0.10 mm, 0.15 mm, 0.45 mm or 0.52 mm were approximately 0.08 mm, approximately 0.06 mm, approximately 0.24 mm, and approximately 0.28 mm, respectively. The relationship between the tip side surface deflection width A and the amount of undulation prevalent on a cut surface of the workpiece W is shown by a line generally drawn through the “X” markers on FIG. 11.

Similar to that described above, the tipped saw blade 10 may be configured to have seventy-two tips 14 of equal length. As described here, the setting line length of the tips 14 is 6.5 mm, and the radial clearance angle thereof is 1°. The tip side surface deflection width A of the tipped saw blade 10 was set to 0.50 mm, while other conditions, dimensions and/or parameters were kept consistent with that described in the earlier embodiments and/or examples. The result of measuring the amount of undulation prevalent on a cut surface of the workpiece W with a tip side surface deflection width A of approximately 0.10 mm is shown by the solid triangle in FIG. 11. Further, the relationship between the tip side surface deflection width A and the undulation amount is shown by a line drawn through the solid triangle in FIG. 11.

Likewise, the tipped saw blade 10 may be configured substantially as described above, with the setting line length of the tips set at 6.5 mm, but with the radial clearance angle thereof set at 40′. The tip side surface deflection width A of the tipped saw blade 10 was set to 0.04 mm or 0.52 mm, and other various conditions, dimensions and parameters were kept consistent with the earlier described embodiments and examples. The results of the measurements taken as described here are shown by solid squares in FIG. 11. In detail, the amount of undulation on a cut surface of the workpiece W at the tip side surface deflection width A at 0.04 mm and 0.52 mm were measured to be approximately 0.01 mm, and approximately 0.08 mm, respectively. The relationship between the tip side surface deflection width A and the amount of undulation is shown by a line drawn through the solid squares in FIG. 11.

In the embodiment discussed earlier and shown by the crosses in FIG. 11, the tips 14 were configured as short tips 40 with the setting line length set at 2 mm. In the configuration as described here and earlier, the tip side surface deflection width A may increase due to the deflection of the rotation shaft 100 and/or of the flange contact surface 105 during cutting and/or machining of the workpiece W. Likewise, the amount of undulation prevalent on a cut surface of the workpiece may also increase proportionately as caused by the increased deflection of the rotation shaft 100.

In the examples indicated by the solid triangle and the solid squares, the setting line length of the tips 14 are 6.5 mm, i.e., greater than 4 mm. It has been found out that, in this case, even when the tip side surface deflection width A increases as a result of the deflection of the rotation shaft 100 and of the flange contact surface 105, the undulation amount of the cut surface of the workpiece W is smaller as compared with comparative examples 1 through 4 indicated by the crosses. Thus, as discussed above with relation to the other examples and/or embodiments, although the tip side surface deflection width A may increase as a result of the deflection of the rotation shaft 100 and of the flange contact surface 105, the amount of undulation observed may not increase as substantially as described by the example shown by the crosses in FIG. 11. However, fabricating the tipped saw blade 10 with only relatively long tips, i.e. tips longer than 4 mm, to achieve reduced undulation as shown in FIG. 11 may result in increased manufacturing and/or production costs.

In an embodiment shown by FIG. 1, a total of six long tips 30 may be positioned intermittently along the periphery of the tipped saw blade 10, i.e. in front of and/or behind the short tips 40, to achieve a desirable undulation reduction during cutting and/or machining of the workpiece W without, for example, greatly increasing manufacturing costs. Also, the solid circles in FIG. 11 show the experimental results of machining with such a configuration of the tipped saw blade 10 as described here, i.e. with six long tips 30. As can be seen in FIG. 11, configuring the tipped saw blade 10 to include six long tips 30 diminishes undulation relative to a tipped saw blade configured with only short tips 40 of, for example, a length of 2 mm each. In an embodiment, the tipped saw blade 10 may be fabricated to have at least two long tips 30, preferably with the number of long tips 30 ranging from 2% to 15% of the total combined number of long tips 30 and short tips 40. Further, in an embodiment, the total combined number of long tips 30 and short tips 40, as described above, for example, may be seventy-two. Moreover, as shown by FIG. 11, configuring the tipped saw blade 10 as described here, i.e. with six long tips 30, may result in an undulation amount similar to that shown by the solid triangle and the solid squares. Thus, configuring the tipped saw blade 10 as described here with, for example, the number of the long tips 30 ranging from 2% to 15% of the combined total number of the long tips 30 and the short tips 40, may result, unexpectedly, in a similar diminished undulation profile and/or amount as that associated with configuring the tipped saw blade with only long tips 30, i.e. as that shown by the solid triangle and the squares in FIG. 11. As a result, the tipped saw blade 10 may be manufactured at a relatively low cost while providing the performance and/or enhanced cutting benefits as that typically associated with a blade having only long tips, i.e. diminished undulation during machining and/or cutting.

As described above, equipping and/or configuring the tipped saw blade 10 with six long tips 30, or with the number of the long tips 30 ranging from 2% to 15% of the combined total number of the long tips 30 and the short tips 40, may sufficiently reduce and/or diminish the amount of undulation prevalent in a cut surface of the workpiece W, even in instances of deflection of the rotation shaft and/or of the flange contact surface 105 during machining Also, as discussed earlier, the tipped saw blade 10 in such a configuration may be manufactured at relatively low cost. Also, in an embodiment, the long tips 30 and the short tips 40 may be formed from expensive materials such as polycrystalline diamond. Thus, when compared with the short tip 40, the long tip 30 may be relatively expensive. However, as described above, the number of the long tips 30 may be limited to only 2% to 15% of all of the tips 14, to control manufacturing costs. Moreover, since the number of short tips 40 is high, the side surface area of all the tips is relatively small. As a result, the time needed to sufficiently polish and/or re-sharpen the tips 14 may be minimized.

While the embodiments and/or examples of invention have been described above with reference to specific configurations, it will be apparent to those skilled in the art that many alternatives, modifications and variations may be made without departing from the scope of the present invention. Accordingly, the above embodiments and/or examples of the present invention are intended to embrace all such alternatives, modifications and variations that may fall within the spirit and scope of the appended claims. Embodiments and/or examples of the present invention should not be interpreted to be limited to the representative configurations, but may be further modified, for example, as described below.

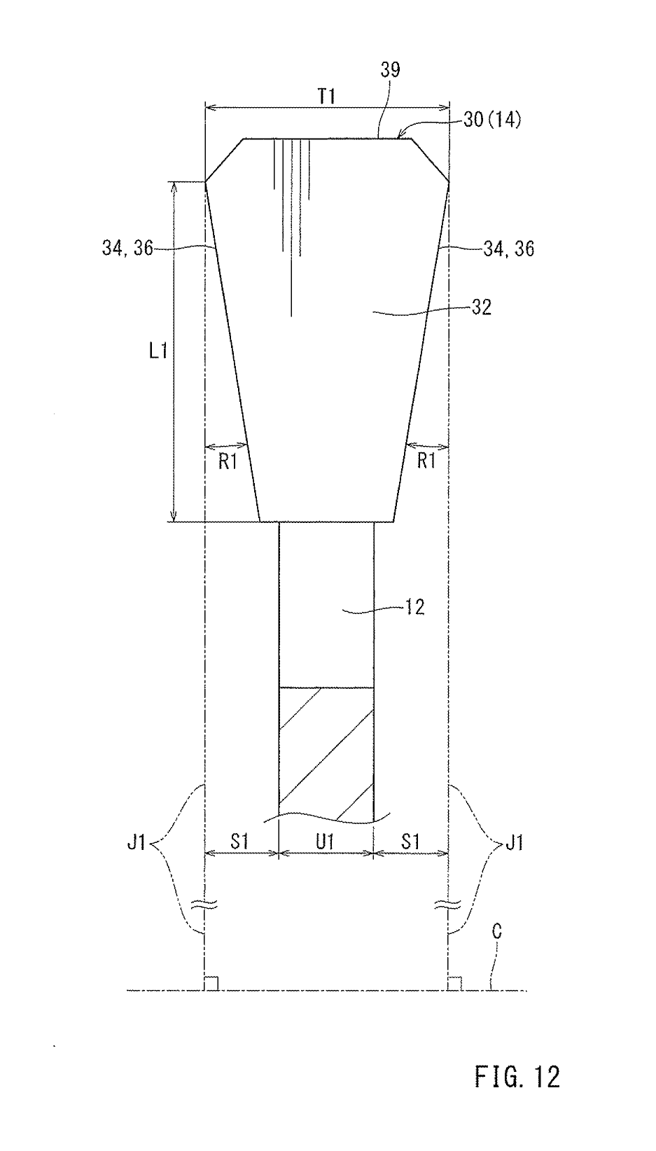

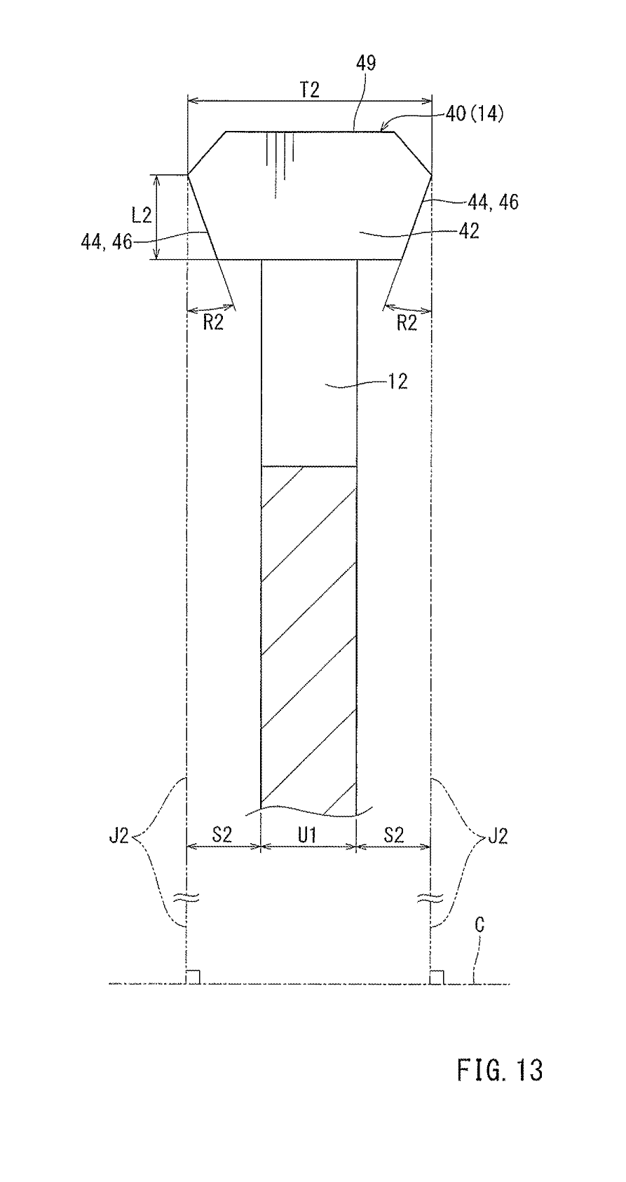

For example, as shown in FIGS. 12 and 13, the long tip 30 and/or the short tip 40 may be formed with an outer peripheral cutting edge 39 or an outer peripheral cutting edge 49, respectively. Accordingly, the cross-section of the long tip 30 or the short tip 40, taken along the line J1 or J2 respectively, may be generally hexagonal, i.e. in having an angle, such as a “face bevel angle”, between a top surface of the long tip 30 and/or the short tip 40 and a side surface thereof. Such a face bevel angle as described above and shown in FIGS. 12 and 13 may assist the tipped saw blade 10 in cutting and/or machining the workpiece W neatly. Further, such a configuration as that described here, i.e. with a face bevel angle, may be especially desirable in circumstances when the tip side surface deflection width A attributable to the deflection of the rotation shaft 100 and/or of the flange contact surface 105 is large.

Also, in an embodiment, the outer peripheral cutting edge 39 of the long tip 30 and/or the outer peripheral cutting edge 49 of the short tip 40 may include surfaces with tangential clearance angles and/or tangential clearance angles configured to assist the tipped saw blade 10 to cut and/or machine the workpiece W neatly as desired.

In detail, as shown in FIG. 12, chamfers may be located at both ends of the outer peripheral cutting edge 39 of the long tip 30. As shown in FIG. 13, chambers may be provided at both ends of the outer peripheral cutting edge 49 of the short tip 40.

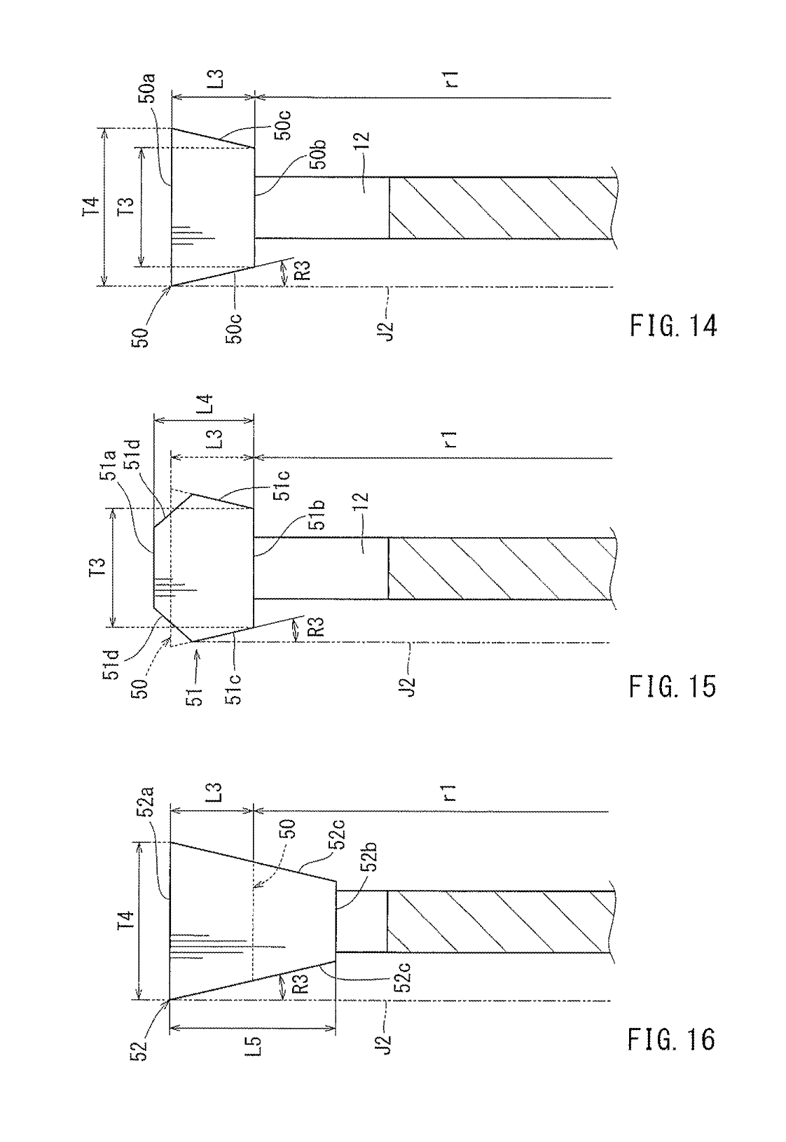

The tipped saw blade 10 may be configured to have first and second short tips 50 and 51 shown in FIGS. 14 and 15, respectively, and a long tip 52 shown in FIG. 16. The first short tip 50 may be formed in in a similar manner as the short tip 40 shown in FIG. 6. In detail, in an embodiment, the cutting surface of the short tip 50 has a lower side 50b of a length T3, an upper side 50a of a length T4, and a setting line length L3. The lower side 50b is set at a distance of r1 from the center of the base metal 12. The short tips 50 and 51 and the long tip 52 may be fabricated and/or configured to have the same radial clearance angle R3.

Similar to the embodiment of the short tip 40 shown in FIG. 13, the second short tip 51 shown in FIG. 15 has chamfers 51d at both ends. The cutting surface of the second short tip 51 has an upper side 51a and a lower side 51b. The lower side 51b has the same length T3 as the lower side 50b of the short tip 50 shown in FIG. 14. Like the lower side 50b, the lower side 51b is set at the distance of r1 from the center of the base metal 12. The upper side 51a of the second short tip 51 is situated on the outer side in the radial direction of the upper side 50a of the firs short tip 50 (i.e., L4>L3).

The long tip 52 shown in FIG. 16 may be formed in a similar manner as the long tip 30 shown in FIG. 4. The cutting surface of the long tip 52 has an upper side 52a, a lower side 52b and a setting line length L5 (i.e., L5>L4>L3). The upper surface 52a has the same length T4 as the upper surface 50a of the short tip 50 shown in FIG. 14. Similar to the upper side 50a of the first short tip 50, the upper side 52a of the long tip 52 may be set at the distance of r1+L3 from the center of the base metal 12.

In an embodiment, the first short tips 50 and the second short tips 51 may be arranged alternately, i.e. one after the other. Further, the long tips 52 of FIG. 16 may be arranged between several second short tips 51 instead of the first short tips 50. Also, the long tips 52 of FIG. 16 may be arranged between some first short tips 50 instead of the second short tips 51 of FIG. 15. Moreover, a plurality of first short tips 50 and a plurality of second short tips 51 may be alternately arranged, and/or several long tips 52 may be provided at predetermined places.

Also, the workpiece W may be conventionally machined and/or cut in a downward cut by the tipped saw blade 10, i.e. positioned above the workpiece W. Alternatively, the mounting orientation of the tipped saw blade 10 may be reversed with respect to the rotation shaft 100. Also, the relative rotational direction Fn of the tipped saw blade 10 may be reversed. Accordingly, the workpiece W may be machined and/or cut by an upward cut by the tipped saw blade 10.

1. A tipped saw blade comprising:
a base metal; and
a plurality of tips attached on an outer periphery of the base metal;
wherein the plurality of tips includes long tips with a setting line length in a radial direction of 4 mm or more, and short tips with a setting line length in the radial direction of less than 4 mm, and
wherein a number of the long tips is 2 to 15% of sum total of numbers of the long and short tips, and is two or more.

2. The tipped saw blade of claim 1, wherein a radial clearance angle of the long tip relative to a radial line in the thickness direction rages from 0° to 1.0°.

3. The tipped saw blade of claim 1, wherein a setting line length of all of the short tips ranges from 1 to 2 mm.

4. The tipped saw blade of claim 1, wherein the total number of the long tips and the short tips combined is seventy-two.

5. The tipped saw blade of claim 1, wherein each tip of the plurality of tips has a chamfered surface connecting an outer peripheral cutting edge of the tip with a side surface of the tip.

6. The tipped saw blade of claim 1, wherein each tip of the plurality of tips is constructed at least in part from polycrystalline diamond.

7. A system for cutting a workpiece comprising:
a rotary cutting blade with a plurality of tips extending from a circumference thereof wherein the plurality of tips comprise a sequence of short tips interrupted by a long tip and further wherein the number of long tips ranges from 2% to 15% of a sum total of the long tips and short tips;
a flange contact surface positioned adjacent to and in contact with the rotatary cutting blade; and
a rotation shaft positioned orthogonal to and inserted through corresponding orifices in the rotary cutting blade and the flange contact surface to provide an axis about which the rotary cutting blade rotates.

8. The system for cutting a workpiece of claim 7, wherein the long tips are adapted to reduce undulation prevalent in cutting a workpiece with the rotary cutting blade.

9. The system for cutting a workpiece of claim 7, wherein each long tip of the long tips has a radial clearance angle wherein side surfaces of the long tip are inclined at the radial clearance angle from both axial ends of an outer peripheral cutting edge of the long tip toward the center of the rotary cutting blade.

10. The system for cutting a workpiece of claim 7, wherein plurality of tips are formed with an outer peripheral cutting edge such that a cross-section of each tip of the plurality of tips is hexagonal.

11. The system for cutting a workpiece of claim 7, wherein the rotary cutting blade is positioned above a workpiece to descend toward the workpiece.

12. A tipped saw blade comprising:
a base metal; and
a plurality of tips arranged consecutively on an outer periphery of the large base metal;
wherein the plurality of tips includes long tips with a setting line length in a radial direction of 4 mm or more, and short tips with a setting line length in the radial direction of less than 4 mm; and
wherein the long tips comprise between 2% to 15% of a sum of the long and short tips combined, wherein at least two or more of the long tips are arranged on the outer periphery of the base metal.

13. The tipped saw blade of claim 12, wherein a radial clearance angle of a long tip of the long tips relative to a radial line orthogonal to an axis of the tipped saw blades ranged from 0° to 1.0°.

14. The tipped saw blade of claim 12, wherein a setting line length of the short tips ranges from 1 to 2 mm.
